(19) United States
(12) Patent Application Publication
(10) Pub. No.: US 2009/0079912 A1
(43) Pub. Date: Mar. 26, 2009

(54) LIQUID CRYSTAL DISPLAY DEVICE

(75) Inventor: Yasufumi Asao, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/912,603

(22) PCT Filed: May 19, 2006
(86) PCT No.: PCT/JP2006/310083

§ 371 Date: Oct. 25, 2007

(30) Foreign Application Priority Data
May 19, 2005 (JP) 2005-147354

(51) Int. Cl. G02F 1/1335; H01J 9/26

(52) U.S. Cl. 349/98; 445/25

(57) ABSTRACT

An inorganic alignment film including an inclined columnar structure is used as an alignment film 123, 125 of a liquid crystal element 120, and a light L1 emitted from a light source 50 for incidence on the liquid crystal element 120 is irradiated to the liquid crystal element 120 through a circularly polarizing means 53. Thereby, variations in optical characteristics which are caused by conventional oblique vapor deposition can be reduced.

### TECHNICAL FIELD

The present invention relates to a liquid crystal display device, and more particularly, to a liquid crystal display device using an inorganic alignment film as an alignment film.

### BACKGROUND ART

At present, liquid crystal display devices have widely been put to practical use. In the future, the liquid crystal display devices are expected to become more and more popular. The liquid crystal display devices can be categorized into a direct view type in which an image having a size equal to that of a liquid crystal element is observed, and a projection type in which an image having a size larger than the size of the liquid crystal element can be observed using a magnifying optical system.

The projection type liquid crystal display device can easily realize large area display and is thus widely used as a front projector for projection from the front of a screen and a rear projector for projection from the rear of a screen.

In the projection type liquid crystal display device, an optical shutter using a liquid crystal for modulating a light from a light source and projecting the light to a screen has the main role. As the optical shutter, there is mainly used a so-called liquid-crystal-on-silicon (LCOS) device in which an electrode and an alignment film are formed on a semiconductor chip having a driver circuit therein, a transparent glass substrate is disposed so as to face the chip surface, and a liquid crystal is disposed therebetween. Further, a transmission type liquid crystal device in which transparent glass substrates are disposed so as to face each other is also used.

In the projection type liquid crystal display device, in order to obtain sufficient brightness on a screen, a liquid crystal shutter is irradiated with an extremely intense light. However, when the conventional liquid crystal shutter is irradiated with such an intense light, there is the problem that the alignment film made of an organic polymer material is degraded to shorten the life thereof.

As a method for solving such a problem, there has been proposed in U.S. Pat. No. 5,745,205 a method in which in place of an organic polymer alignment film such as a polyimide film that has been widely used hitherto, an alignment film comprised of an inorganic material is used. In general, since the organic alignment film is inferior in light resistance, using the inorganic alignment film in place of the organic alignment film makes it possible to suppress the degradation of the displaying quality resulting from the irradiation with the intense light.

A typical method of forming a liquid crystal alignment film using an inorganic material is an oblique vapor deposition of a silicon oxide (hereinafter represented by SiOx). SiOx as a vapor deposition source is set in a vacuum atmosphere and then heated at a high temperature or irradiated with an electron beam so that SiOx molecules are vaporized and deposited on a substrate for vapor deposition from an oblique direction. The SiOx deposited on the substrate forms inclined fine columnar structures (hereinafter referred to as columns). It is considered that liquid crystal molecules are aligned along the columns.

The term “vapor deposition orientation” as herein employed refers to an orientation in which a vapor deposition beam travels to a respective position on the substrate, and the term “vapor deposition angle” as herein employed refers to an angle formed between the vapor deposition beam and a normal to the substrate. The vapor deposition angle is an incident angle of the vapor deposition beam on the substrate in the vapor deposition orientation.

According to the experiences of the present inventors, the orientation in which a column grows substantially coincides with the vapor deposition orientation. On the other hand, the vapor deposition angle and the angle of a formed column relative to the substrate are not identical to each other but have a predetermined correlation. Further, the vapor deposition angle is a most important factor for controlling a pretilt angle of the liquid crystal.

One of problems involved in the oblique vapor deposition is that, because of the vapor deposition from a point-like vapor deposition source, the vapor deposition orientation and the vapor deposition angle differ from each other at respective points on the substrate for deposition, with the result that the growing directions of columns in plane are not uniform and the columns are formed in different orientations and at different angles in respective locations on the substrate.

In order to suppress the variation in the column growing direction, there has been proposed in Japanese Patent Application Laid-open No. S63-172121 a method of uniforming the vapor deposition angles using a mask having a slit provided therein.

In this case, it is disclosed that the vapor deposition angle is determined depending on the positional relationship between a vapor deposition source and the slit and thus a substantially constant vapor deposition angle is obtained.

However, even in this method, the vapor deposition angle and the vapor deposition orientation do not become completely uniform on the substrate. This is because the direction of a vapor deposition beam from the vapor deposition source has an angle distributed along the length of the slit. When the vapor deposition angles are different from each other, the pretilt angles of the liquid crystal will differ from each other. Further, a variation in vapor deposition orientation will generate a variation in alignment orientation of liquid crystal molecules. Hereinafter, the influence of the liquid crystal alignment on the optical characteristics will be described.

FIG. 10 is a graphical representation showing a result obtained by calculation, indicating the extent to which the reflectance of a reflection type liquid crystal shutter is changed depending on the pretilt angle of a liquid crystal. It is assume herein that the liquid crystal is a liquid crystal of a so-called vertical alignment (VA) mode in which the liquid crystal molecules are aligned perpendicular to the substrate when no voltage is applied and become inclined with an applied voltage. When the voltage is 0 V, a light does not pass through the liquid crystal, and the liquid crystal molecules are inclined with an increasing voltage so that the light becomes to pass through the liquid crystal. The pretilt angle of the liquid crystal is determined depending on the vapor deposition angle during the oblique vapor deposition. However, as described above, since the vapor deposition angle during the oblique vapor deposition varies, the pretilt angle is changed depending on a position in a wafer in which the chip is cut out. Three curves shown in FIG. 10 indicate reflectances at the pretilt angles of 90°, 88°, and 86°.

It can be seen from FIG. 10 that the reflectance is considerably changed by a variation of several degrees in the pretilt angle.

FIG. 11 is a graphical representation showing a variation in reflectance in the case where the inclination orientation of liquid crystal molecules in a liquid crystal of the VA mode is changed under application of a voltage. The inclination orientation of the liquid crystal molecules is the inclination orientation of the SiOx columns which is determined depending on the vapor deposition orientation during the oblique vapor deposition. As described above, since the vapor deposition orientation during the oblique vapor deposition varies, the inclination orientation of the columns is changed depending on a position in a wafer in which the chip is cut out. FIG. 11 shows a change in reflectance in each of the inclination orientations of the liquid crystal molecules of 45°, 40°, and 30° with respect to a polarization axis.

As shown in FIG. 11, the vapor deposition orientation varies for each chip, so that the inclination orientation of the liquid crystal molecules changes, with the result that the maximal value of the reflectance lowers as the inclination orientation is deviated from 45°.

The above description has been made taking the variation in reflectance of the reflection type liquid crystal display element as an example. However, in a transmission type liquid crystal element using the VA mode, similar variation in transmittance occurs.

Because a semiconductor chip in which a liquid crystal shutter is formed has a size of several millimeters to several centimeters, it may be assumed that liquid crystal orientation characteristics of the liquid crystal and the optical characteristics determined thereby are uniform in the chip. However, when a silicon wafer of several inches in diameter is subjected to vapor deposition, column directions at both ends of the wafer are considerably different from each other. When the wafer is scribed to produce chips, there is a nonnegligible variation among the chips. In particular, when the alignment orientation of the crystal in a substrate plane varies for each chip, the optical axis of the liquid crystal shutter is not fixed. Therefore, when mounted on a projector, the optical axis of the liquid crystal shutter is offset with respect to a fixed optical axis of the projector. This critically impairs the contrast of a displayed image.

Further, in many projection type liquid crystal display devices, three liquid crystal shutters are used corresponding to the three primary colors. However, when the characteristics of the respective shutters are different from each other as described above, a displayed color varies for each product, so that constant color reproduction cannot be obtained. In addition, the displaying quality of each product is not improved.

Further, since it is necessary to suppress the variation among liquid crystal shutters to a narrow range, only chips cut from a very small portion of a wafer can be used. Therefore, it is difficult to reduce the production cost per chip.

### DISCLOSURE OF THE INVENTION

It is, therefore, an object of the present invention to provide a liquid crystal display device in which the above described deterioration of characteristics resulting from a variation in a pretilt angle and a deviation in an optical axis of a liquid crystal element formed by the oblique vapor deposition is suppressed and which has no variation in the characteristics, as described above.

According to one aspect of the present invention, there is provided a liquid crystal display device, comprising a liquid crystal element comprising a pair of substrates, an alignment film provided on at least one of the pair of substrates and comprising an inclined columnar structure of an inorganic substance, and a liquid crystal disposed between the pair of substrates; and a light source, wherein a light from the light source is modulated and exited, the liquid crystal display device further comprising means for converting the light from the light source into a circularly polarized light and making the circularly polarized light enter the liquid crystal element.

According to another aspect of the present invention, there is provided a method of producing a liquid crystal display device, comprising the steps of:

(1) disposing a substrate in a vacuum vessel having a vapor deposition source and a plate member with a slit disposed therein such that the substrate is within a plane parallel to the slit and is inclined with respect to a line connecting the vapor deposition source and the slit;

(2) radiating the substrate with a vapor from the vapor deposition source through the slit;

(3) moving the substrate in a direction which is perpendicular to a longitudinal direction of the slit and is parallel to a surface of the plate member;

(4) bonding the substrate to another substrate to form a cell;

(5) cutting the bonded two substrates into a plurality of cells;

(6) injecting a liquid crystal into the cell; and

(7) attaching the liquid crystal injected cell to an optical device having a circularly polarizing means.

In the liquid crystal display device using the inorganic alignment film according to the present invention, by converting an incident light from a light source into a circularly polarized light and irradiating a liquid crystal shutter with the converted light, a high-quality image can be displayed without lowering the contrast even when an optical axis is deviated by a variation in vapor deposition angle. Because the vapor deposition orientation may be varied, it is possible to select a vapor deposition method in which a wide variation in vapor deposition orientation is allowed and a variation in vapor deposition angle can be made small, with the result that a variation in pretilt angle can be suppressed as small as possible. Further, since the chip yield can be increased, the production cost of a liquid crystal shutter can be reduced, thereby providing a low-cost liquid crystal display device.

### BRIEF DESCRIPTION OF THE DRAWINGS

FIG. 1 is a cross-sectional view showing a structure of a liquid crystal element;

FIG. 2 is a cross-sectional view showing a structure of a vapor deposition apparatus;

FIG. 3 is a cross-sectional view showing another structure of a vapor deposition apparatus;

FIG. 4 is a front view showing the vapor deposition apparatus shown in FIG. 3;

FIG. 5 is a graphical representation showing a relationship between a distance from a vapor deposition source and a maximum deviation angle of an easy orientation axis;

FIG. 6 is a graphical representation showing a relationship between a distance from a vapor deposition source and a vapor deposition angle;

FIG. 7 is a cross-sectional view showing another structure of a vapor deposition apparatus;

FIG. 8 is a side view showing the vapor deposition apparatus shown in FIG. 7;

FIG. 9 is a graphical representation showing a relationship between a distance from a vapor deposition source and a vapor deposition angle;

FIG. 10 is a graphical representation showing a relationship between a voltage applied to a liquid crystal shutter and reflectance with a vapor deposition angle being a parameter;

FIG. 11 is a graphical representation showing a relationship between a voltage applied to a liquid crystal shutter and reflectance thereof with a vapor deposition orientation being a parameter;

FIG. 12 is a schematic view showing a liquid crystal display device according to an embodiment of the present invention;

FIG. 13 is a cross-sectional view showing rotary type oblique vapor deposition;

FIG. 14 is a schematic view showing a liquid crystal display device according to another embodiment of the present invention;

FIG. 15 is a schematic view showing a structure of a circularly polarizing means; and

FIG. 16 is a view showing a liquid crystal display device according to still another embodiment of the present invention.

### BEST MODE FOR CARRYING OUT THE INVENTION

Next, embodiments of the present invention will be described with respect to a reflection type liquid crystal display element.

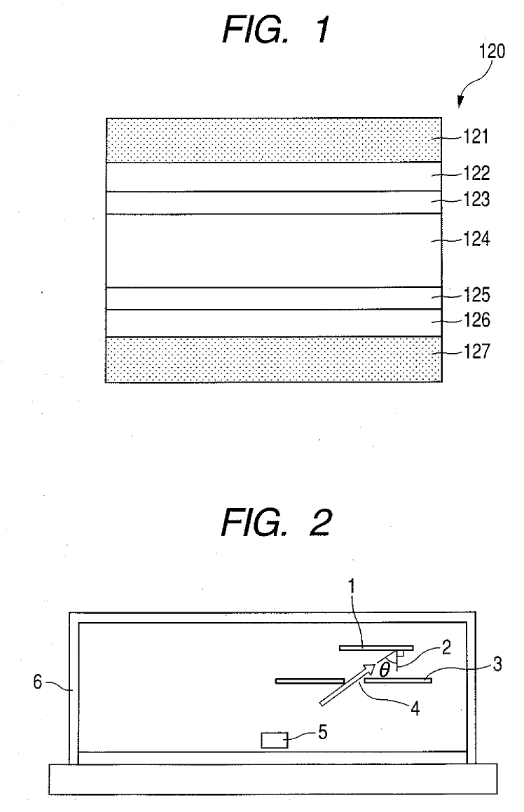

FIG. 1 is a cross-sectional view showing a structure of a liquid crystal device provided in a liquid crystal display device such as a projector.

In FIG. 1, a liquid crystal shutter 120 includes a glass substrate 121 and a silicon substrate 127 which are bonded to each other to form a pair, electrodes 122 and 126 formed on the respective substrates, alignment films 123 and 125 formed on the surfaces of the electrodes, and a liquid crystal layer 124.

A light is incident on the liquid crystal shutter 120 from above in FIG. 1, reflected by the lower electrode 126 made of metal such as aluminum, and exits toward above in the figure again.

The alignment films 123 and 125 are formed on the substrates by oblique vapor deposition illustrated in FIG. 2. In FIG. 2, a vapor deposition source 5 is a point source, and a vapor deposition beam is incident on a substrate 1 through a slit 4 provided in a plate 3 (hereinafter also referred to as “slit plate”) as indicated by an outline arrow. The substrate 1 is disposed at an angle θ with respect to the vapor deposition beam. The slit 4 is provided perpendicular to a moving direction of the substrate.

As a vapor deposition substance, SiO is used in many cases. When the substrate on which SiO is vapor deposited is observed using an electron microscope, inclined columnar structures are formed on the substrate. It is considered that the liquid crystal molecules are arranged by the columnar structures. SiO₂ may be used instead of SiO. Other inorganic substances that form columnar structures may be used.

### (Circular Polarization Optical System)

In the present invention, a light incident on a liquid crystal shutter is converted into a circularly polarized light. By providing circular polarization, it is possible to obtain a constant transmittance independently of a variation in molecular inclination orientation.

FIG. 12 is a view schematically showing a liquid crystal display device according to the present invention, which includes an optical system for providing circular polarization to a liquid crystal element.

A light L1 emitted from a light source 50 is bent at a right angle by a half transmission plate 55 and then incident on a liquid crystal element 120. a light from an ultra-high pressure mercury lamp normally used as the light source 50 has a random polarization plane.

Above the liquid crystal element 120, there is disposed a circularly polarizing means 53 in which a linearly polarizing plate 51 and a quarter-wave plate (λ/4 plate) 52 are stacked, and a light passing therethrough becomes a circularly polarized light.

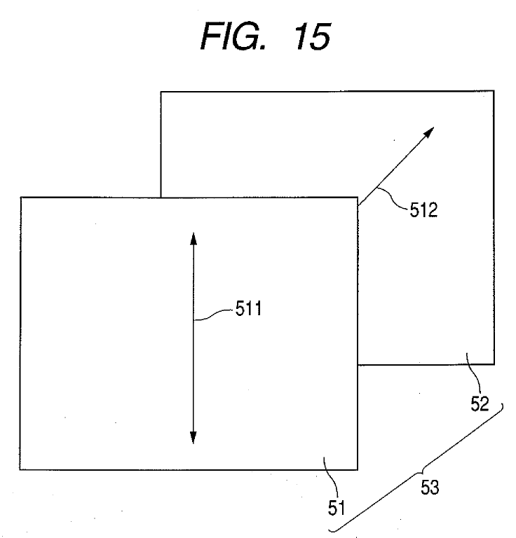

FIG. 15 schematically shows a stack structure of the circularly polarizing means 53. A transmission axis 511 of the linearly polarizing plate 51 and a phase delay axis 512 (axis which maximizes a phase delay of the transmitted light) of the λ/4 plate 52 form an angle of 45° and a light entering the linearly polarizing plate 51 becomes a right circularly polarized light and exits from the λ/4 plate 52.

If necessary, by further stacking a half-wave plate (λ/2 plate), a light can be converted into a circularly polarized light in a wavelength region of a wide band over the entire visible light. At this time, it is preferable that the λ/2 plate be disposed to set the optical axis thereof at an angle of 15° relative to the polarization axis and that the λ/4 plate be located to set the optical axis thereof at an angle of 75° relative to the polarization axis. Alternatively, a wide-band quarter-wave plate having a so-called inverse dispersion characteristic may be used by being positioned to set the optical axis thereof at an angle of 45° relative to the polarization axis.

When the liquid crystal molecules are aligned perpendicularly to the substrate, a light is reflected without being modulated by the liquid crystal layer and exits as such. Since the reflecting surface is formed of the metallic electrode 126, the phase is not changed by the reflection. Therefore, the reflected light is a left circularly polarized light of opposite rotation.

The light which has exited from the liquid crystal element 120 passes through the quarter-wave plate (λ/4 plate) 52 (or phase difference plate in which a quarter-wave plate and a half-wave plate are stacked) again and becomes a linearly polarized light whose polarization plane is orthogonal to that at the time of incidence because of being the left circularly polarized light. As a result, the light is absorbed by the linearly polarizing plate 51 and thus does not exit upwardly from the circularly polarizing means 53.

When a voltage is applied to the liquid crystal element 120, the liquid crystal molecules are inclined with respect to the substrate, so that there is generated in the liquid crystal element 120 an optical anisotropy with the inclination direction being an axis. Here, it is assume the case where a circularly polarized light is incident perpendicularly to the liquid crystal element. When the circularly polarized light is divided into two components in the optical axis direction and an axis direction perpendicular thereto, one component in the optical axis direction is delayed in phase as compared with the other component perpendicular thereto.

If the refractive index anisotropy of the liquid crystal and the thickness of the liquid crystal layer are optimally selected, at the time of most bright display, the light which is reflected and exits has a component in the optical axis direction which is delayed by 180° as compared to the component perpendicular thereto. When the two components of the light which have exited are combined with each other again, the resultant light is a right circularly polarized light whose traveling direction is opposite to that of the incident light and whose rotation is identical to that thereof.

The above description is independent of an angle formed between the optical axis of the liquid crystal element 120 and the transmission axis of the linearly polarizing plate 51 or the phase delay axis of the λ/4 plate. Therefore, even when the optical axis direction is changed, the right circularly polarized light of the incident light is always made to exit as the right circularly polarized light. Similarly, when the incident light is a left circularly polarized light, the exiting light becomes a left circularly polarized light.

The light which has become a right circularly polarized light and exited from the liquid crystal element 120 is converted by the λ/4 plate 52 into a linearly polarized light whose polarization plane is identical to that of the incident light and passes through the linearly polarizing plate 51. Then, the light enters a magnifying optical system (not shown) located above through the half transmission plate and magnified thereby to be projected onto a screen (not shown).

The inclination plane of the liquid crystal when a voltage is applied to the liquid crystal element 120 is determined depending on the vapor deposition orientation of the liquid crystal alignment film and therefore varies for each chip. However, as described above, when the liquid crystal element 120 is irradiated with a circularly polarized light, the same polarization modulation is obtained independently of the inclination direction of the liquid crystal molecules. Thereby, a work such as adjustment of an optical system for each chip is unnecessary, so that the adjustment of performance at the time of production is simplified. Further, adoption of this system for a projection type liquid crystal display device using a plurality of (usually three) liquid crystal elements 120 is effective because there can be obtained characteristics with less variation for all the three liquid crystal elements.

As described above, by using the quarter-wave plate (λ/4 plate) 52 for polarizing the incident light from the light source 50, and by converting the light from the light source 50 into an elliptically polarized light or a circularly polarized light and irradiating the liquid crystal elements 120 with the converted light, it is possible to stably produce a liquid crystal display device in which the inorganic alignment film is formed by the oblique vapor deposition.

A transmission type liquid crystal element can also be used as the liquid crystal element using the circularly polarized light in the present embodiment as described above. In this case, it is necessary to dispose the circularly polarizing means on each of the light exit side and the light incidence side of the liquid crystal element 120.

The present invention can be applied to not only the projection type liquid crystal display device using the magnifying optical system but also a direct view type display. The entire substrate may be used as a single liquid crystal element, or each of small parts into which the substrate is divided may be used as a liquid crystal element.

Although the above description has been made by taking the vertical alignment mode as an example of the liquid crystal mode, various alignment modes such as a parallel alignment mode, a HAN (hybrid alignment in which upper and lower pretilt angles are different from each other) mode, and an OCB mode can be used for the present invention. A slight twisted alignment may be present within a range in which the optical characteristics are not adversely influenced. Further, depending on the liquid crystal mode, an alignment film formed by oblique vapor deposition may be provided on only one of the substrates.

Moreover, the above description has been made by taking the case where a circularly polarized light is used in place of a linearly polarized light, but even when using an elliptically polarized light instead of a completely circularly polarized light, an improvement effect can be obtained as compared with the case where a linearly polarized light is used.

As a technique for coloration, a color filter may be used or a color display method based on time division may be employed.

Also in the case of the projection type liquid crystal display device using a plurality of liquid crystal elements, that is, a so-called three plate type projection liquid crystal display device using three liquid crystal elements for separately modulating red light, green light, and blue light, the film formation method and the optical system which are described herein in detail can be used.

In a conventional device, when the direction of an easy orientation axis is offset with respect to a set value by approximately 1°, the transmitted light intensity varies by approximately 1%. Therefore, for example, when the red becomes brighter by 1% and the blue becomes darker by 1%, the color temperature of the image becomes lower. On the other hand, for example, when the red becomes darker by 1% and the blue becomes brighter by 1%, the color temperature of the image becomes higher. As a result, when two products are placed adjacent to each other and observed for comparison, the white balances thereof are different from each other, so that product reproducibility cannot be obtained. In other words, when product quality is to be severely controlled using a conventional optical system, it is considered that even a variation of about 1 degree in easy orientation axis is not allowed.

On the contrary, according to the present invention, even for an element having a variation in easy orientation axis which is caused when a general-purpose vapor deposition apparatus is used, that is, an element having a deviation of 1 or more degree in easy orientation axis, substantially the same optical characteristics can be obtained. Therefore, the present invention can be applied to such a product without any problems. Thus, this is effective for reduction of loads on a production process and furthermore for reduction of the production cost. In addition, this makes it possible to obtain a projection type liquid crystal display device having good color reproducibility.

Although the above description has been made by taking the oblique vapor deposition as an example, the present invention can be applied to various alignment control methods such as an oblique sputtering method, an alignment control method utilizing an optical alignment film using a point light source of ultraviolet light, and a method of controlling a surface shape by sandblast, an ion beam, or the like.

### (Production Method of Oblique Vapor Deposition Film)

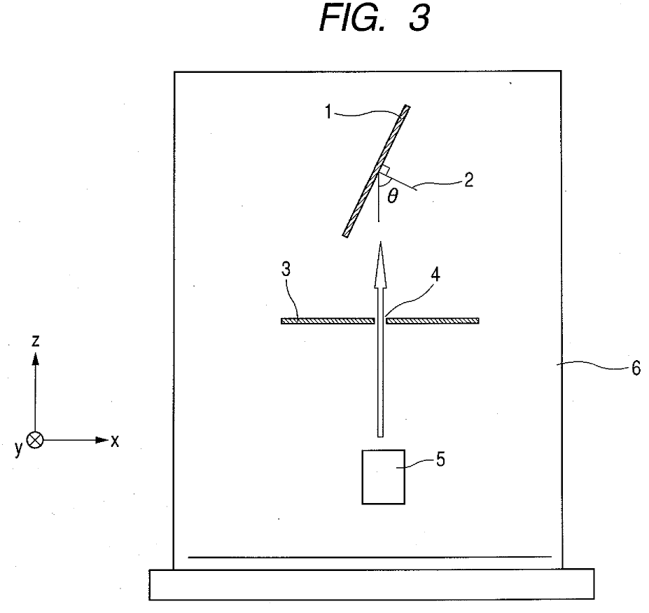

The vapor deposition angle in vapor deposition from a point source will have an in-pane distribution. This will be described with reference to the vapor deposition apparatus shown in FIG. 2 and a vapor deposition apparatus shown in FIG. 3 which is a modified example of the apparatus shown in FIG. 2.

FIG. 2 is a schematic cross-sectional view showing the vapor deposition apparatus used to produce a liquid crystal display device according to the present invention. A vapor deposition source 5 and a plate (slit plate) 3 having a slit 4 therein are fixedly disposed in a vacuum vessel 6, and the substrate 1 is movable in a predetermined direction. In FIG. 2, the slit 4 extends in a direction which parallel to the surface of the substrate 1 and is perpendicular to the drawing plane of FIG. 2, and the substrate 1 is movable in a direction which is perpendicular to the extending direction (that is, the longitudinal direction) of the slit 4 and is parallel to the surface of the slit plate 3. A beam of SiO which is a vapor from the vapor deposition source 5 passes through the slit 4 and is obliquely incident on the substrate 1 as indicated by the outline arrow. The angle θ shown in FIG. 2 is an angle formed between a shortest distance vector 4 of the vapor deposition source 5 to the substrate 1 and a normal 2 to the substrate 1. FIG. 3 is a schematic cross-sectional view showing a system in which the angular relationship between the vapor deposition source 5 and the substrate 1 is identical to that shown in FIG. 2 and the substrate 1 is movable in a direction perpendicular to a vapor deposition beam. In FIG. 3, the moving direction of the substrate 1 is the x-axis direction.

In the both systems shown in FIGS. 2 and 3, the angle formed between the traveling direction of a vapor radiated from the vapor deposition source 5 through the slit 4 and the substrate 1 becomes constant.

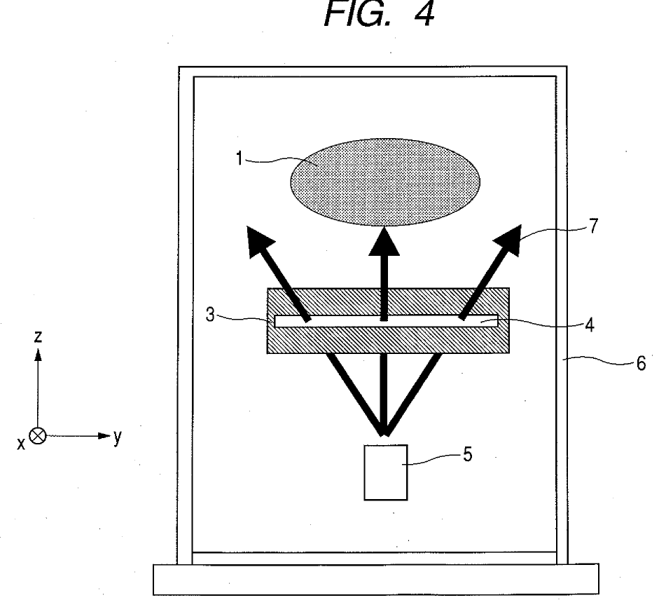

However, the constant vapor deposition angle θ is established for only vapor which passes through the slit perpendicularly to the longitudinal direction of the slit, and the vapor deposition angle and the vapor deposition orientation become deviated from each other for vapor which passes through the slit obliquely to the longitudinal direction of the slit. FIG. 4 is a conceptual diagram of the configuration of FIG. 3 as viewed from the x-axis direction. As shown in the figure, since a vapor 7 from the vapor deposition source 5 is radially spread, the column growing direction has a distribution.

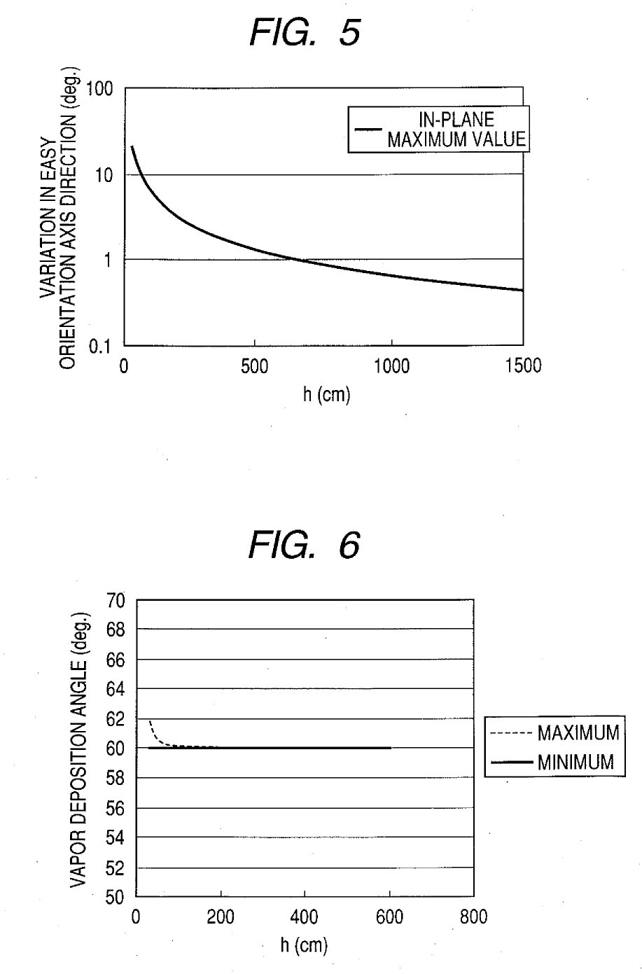

A maximum deviation in vapor deposition orientation angle direction, that is, a distribution amount θ_{A1} can be expressed by the following equation (1):

$${θ}_{A 1} = {tan}^{- 1} ( \frac{r}{h sin Θ} ) \qquad ( 1 )$$

wherein, r represents the radius of the substrate 1, h represents the distance from the vapor deposition source 5 to the center of the substrate, and 8 represents the vapor deposition angle at the center of the substrate. FIG. 5 shows a relationship between h and the distribution amount θ_{A1} (amount of variation in easy orientation axis direction) in the case where the size of the substrate is 8 inches (radius r=10 cm) and the vapor deposition angle Θ at the center of the substrate is 60°.

It can be seen from FIG. 5 that in order to suppress the amount of variation in easy orientation axis direction to be 1° or less, it is necessary to set the distance from the vapor deposition source 5 to the substrate 6 m or more. In other words, in order to reduce a variation in column orientation, that is, a variation in easy orientation axis direction of a liquid crystal in the case of the oblique vapor deposition, it is necessary to significantly increase the distance between the vapor deposition source 5 and the substrate 1.

When a vapor deposition angle θ at a position distant by r from the center of the substrate is precisely calculated, it depends on r as shown by the flowing equation (2) and has an in-plane variation.

$$θ = \pm {cos}^{- 1} ( \frac{cos Θ}{\sqrt{1 + {( \frac{r}{h} )}^{2}}} ) \qquad ( 2 )$$

This relationship is shown in FIG. 6. According to FIG. 6, when the distance between the vapor deposition source 5 and the substrate 1 is 1 m or more, the variation in vapor deposition angle is 1° or less. Therefore, when an apparatus is used in which the distance between the vapor deposition source 5 and the substrate 1 is approximately 1 m, the vapor deposition angle θ can be assumed to be substantially constant.

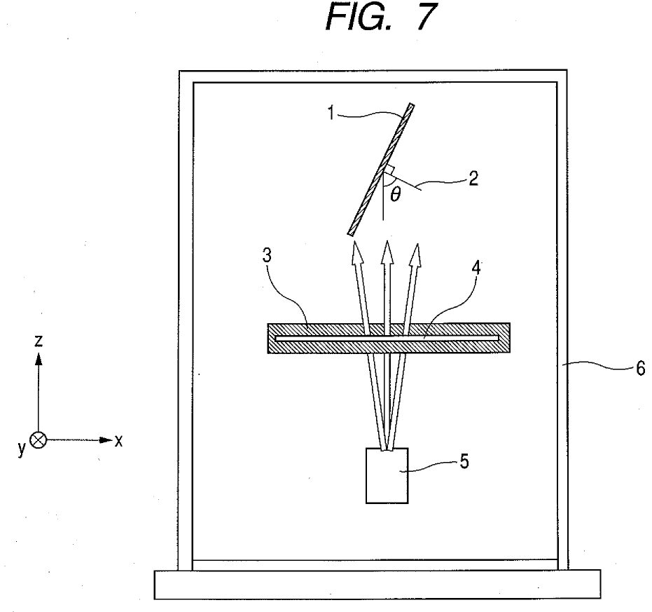

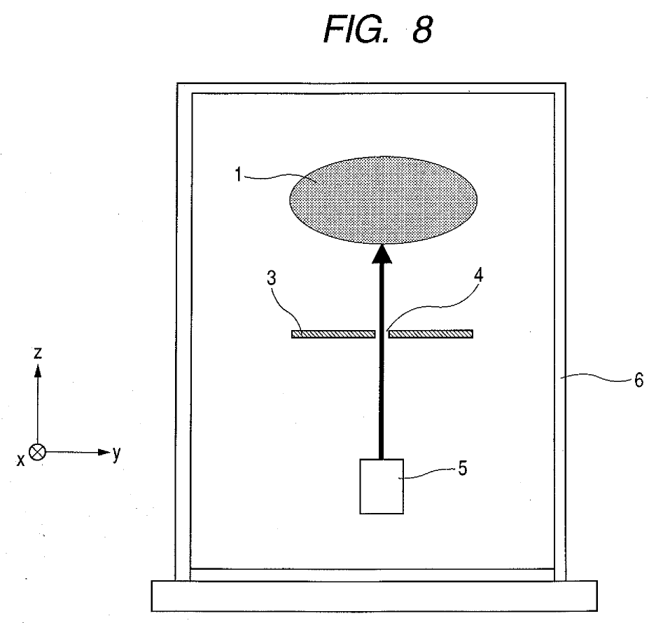

FIGS. 7 and 8 conceptually show, for comparison, a configuration of an apparatus in which a slit 4 is provided so as to extend in a direction crossing the surface of a substrate 1, that is, in the x-axis direction. By moving the substrate 1 in the y-axis direction, vapor deposition is performed to the entire surface of the substrate. When the slit 4 is disposed in such a direction, the variation in in-plane orientation angle distribution is eliminated.

However, as shown in FIG. 7, the vapor deposition angle is distributed along the slit, with the result that the pretilt angle of the liquid crystal molecule varies within the substrate plane.

When the vapor deposition angle at the center of the substrate 1 is represented by 8, the distribution width of the vapor deposition angle can be expressed by the following equation (3).

$${tan}^{- 1} ( \frac{sin Θ - \frac{r}{h}}{cos Θ} ) < θ < {tan}^{- 1} ( \frac{sin Θ + \frac{r}{h}}{cos Θ} ) \qquad ( 3 )$$

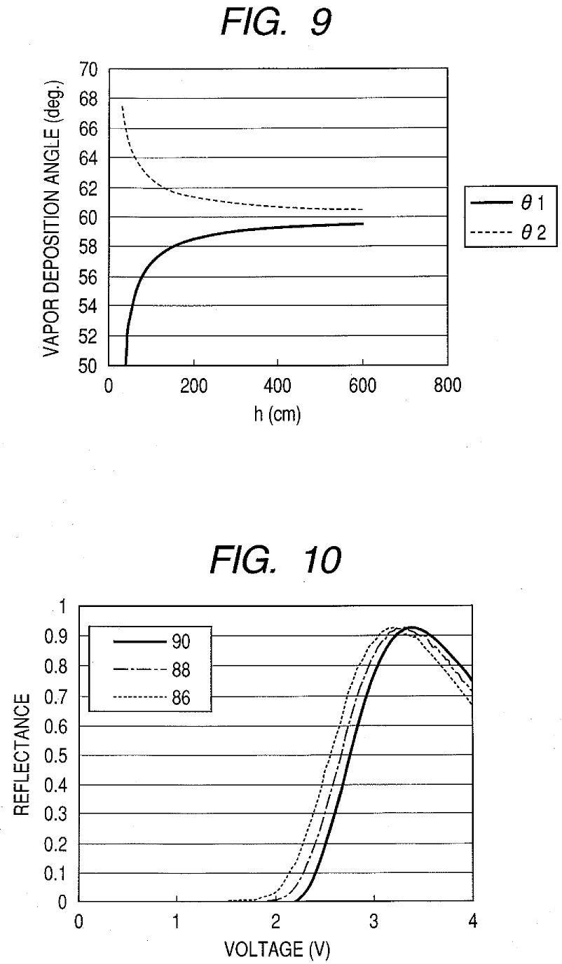

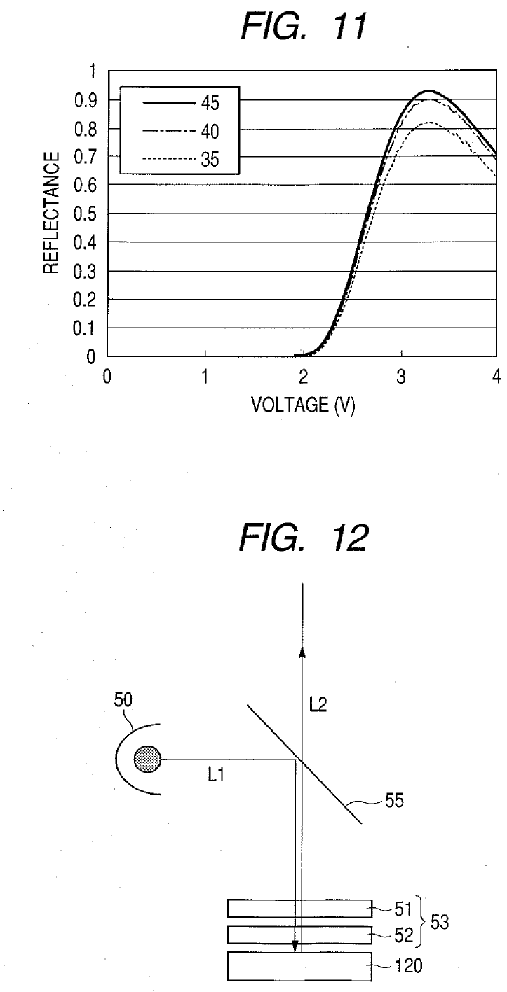

FIG. 9 is a graphical representation showing a relationship between the distance h between the vapor deposition source 5 and the center of the substrate and the vapor deposition angle θ as expressed by the equation (3). In the figure, the solid line represents the plot for the lower limit 91 of the vapor deposition angle θ, namely the left side values of the equation (3), while the dashed line represents the plot for the upper limit 92 of the vapor deposition angle θ, namely the right side values of the equation (3). It can be seen from FIG. 9 that when the variation in vapor deposition angle is set to be 1° or less, it is necessary to set “h” to be 300 cm or more. Thus, even when the forming direction of the slit is changed, in order to reduce the variation in pretilt angle, it is necessary to significantly increase the distance between the vapor deposition source 5 and the substrate 1. However, in a vapor deposition apparatus satisfying such a condition, it may be difficult to maintain a vacuum state and to perform maintenance of the apparatus.

Further, when compared on the same value of “h”, the variation in vapor deposition angle as shown in FIG. 9 is significantly larger than that as shown in FIG. 6. This means that the variation in pretilt angle in the case where vapor deposition is performed in the configuration shown in FIGS. 7 and 8 becomes larger than that in the case of the configurations shown in FIGS. 2 to 4. As shown in FIG. 10, when the pretilt angle varies (for example, 86°, 88° and 90°), the optical response characteristics including a threshold voltage, a voltage providing a maximum reflectance, and the like significantly change. Therefore, the vapor deposition method as shown in FIGS. 7 and 8 has an advantage that the inclination orientation angles of the liquid crystal molecules become uniform. However, the variation in optical characteristics depending on the pretilt angle becomes larger, so that it is less advantageous than the method shown in FIGS. 3 and 4.

Incidentally, if liquid crystal molecules have twisted structures when inclined, the optical characteristics will change depending on the twist angle. In order to avoid this, it is effective that one of the substrates is treated to completely have vertical alignment property.

When one substrate is substrate A with complete vertical alignment property and the other substrate is substrate B having vapor deposition angles varied within the substrate plane, the inclination orientation of the liquid crystal is determined by the substrate B and is not influenced by the alignment film of the substrate “A”. Therefore, the liquid crystal molecules can be aligned without being twisted and only the inclination orientation angle can be varied for each element. In the present invention, since a circularly polarized light is used, the optical characteristics are not influenced by the inclination orientation angle. Thus, by adopting a combination of the substrates A and B, it becomes possible to obtain a liquid crystal element whose optical characteristics do not vary at all.

As described above, by converting a light for irradiation to a liquid crystal element into a circularly polarized light, it becomes possible to eliminate the influence of the in-substrate-plane orientation angle on the optical characteristics, so that a large-area process using the oblique vapor deposition becomes available.

Furthermore, because a variation in inclination orientation angle of a liquid crystal within a substrate plane can be neglected, it becomes possible to reduce the size of a vapor deposition apparatus. Therefore, it is possible to realize a liquid crystal production process of a low cost and a high productivity. Moreover, since an inorganic material alignment film such as of SiO can be used, durability to intense light irradiation is improved.

Hereinafter, the present invention will be described in detail with reference to examples.

### (Structure and Production Method of Liquid Crystal Display Device Common to All Examples)

A liquid crystal material whose dielectric anisotropy Δ∈ is negative (MLC-6608 (trade name); manufactured by Merck & Co., Inc.) is used as the liquid crystal element 120 shown in FIG. 1, and the cell thickness of the liquid crystal layer 124 is set to 3.5 μm. The substrates 121, 127 used each have a diameter of 8 inches. The substrate may be a silicon wafer or a glass substrate. A combination of such two kinds of substrates may be adopted. A circuit for driving the liquid crystal is produced in advance on one of the substrates.

A method of producing the liquid crystal element 120 is as follows.

A SiO alignment film is formed on the entire surface of each of the substrates by the oblique vapor deposition described in the following examples. Alternatively, one of the substrates may be subjected to another alignment treatment to impart vertical alignment property. Then, the two substrates 121, 127 are bonded such that the surfaces thereof having the alignment films provided thereon face each other, thereby forming a cell. At this time, in order to uniform the vapor deposition orientations of the two substrates, one of the substrates is turned over with respect to the vapor deposition axis and then bonded to the other substrate. When one of the substrates is subjected to vertical alignment treatment and has no directionality, it is not particularly necessary to uniform the orientations.

The bonded member is cut into a predetermined size to obtain a plurality of cells, followed by injection of the liquid crystal, sealing (encapsulation), and then connection to a peripheral circuit to thereby complete the liquid crystal element 120. The liquid crystal element 120 thus produced is incorporated into a projection optical system including a circularly polarizing plate, thereby obtaining a liquid crystal display device.

In the incorporation, positional adjustment is performed such that a circuit produced in advance in the substrate and a pixel array have an adequate orientation with respect to the optical device. At this time, because the optical characteristics are not influenced by the alignment orientation of the liquid crystal, it is not necessary to pay any particular attention to the alignment orientation when attaching the liquid crystal element to the optical device.

### EXAMPLE 1

In this example, the alignment films 123, 125 are formed by the vapor deposition apparatus of the configuration as shown in FIG. 2 to produce a liquid crystal element. At this time, the distance between the vapor deposition source 5 and the substrate 1 is set to 1 meter. The liquid crystal element is used to obtain a projection type liquid crystal display device.

With respect to an optical system of the projection type liquid crystal display device, two types of optical systems, an optical system for making a linearly polarized light enter the liquid crystal element and an optical system for making a circularly polarized light enter the liquid crystal element, are compared with each other.

In the case of the projection type liquid crystal display device using the linearly polarized light, a variation in contrast is caused according to the attached liquid crystal element. On the other hand, in the case of the projection type liquid crystal display device using the circularly polarized light, stable display with substantially no variation in contrast is attained.

### EXAMPLE 2

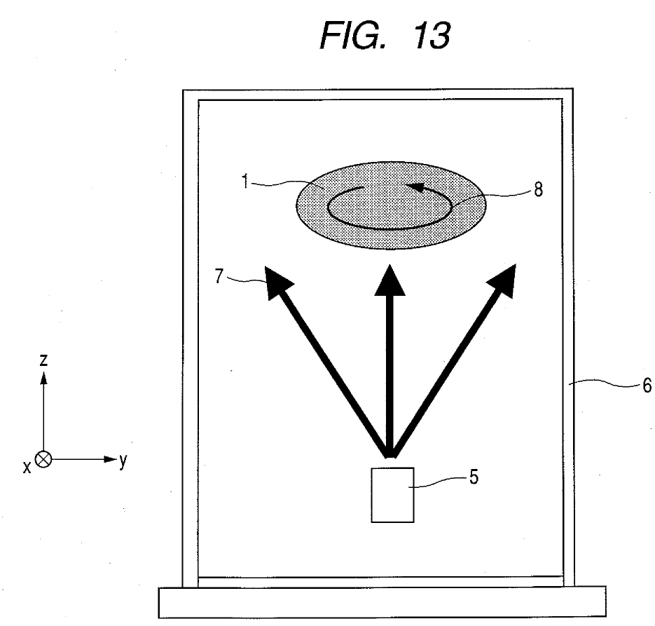

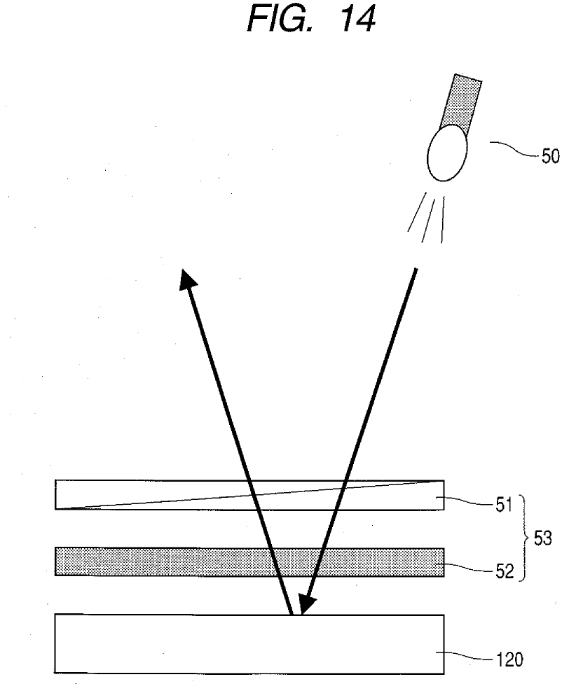

In this example, an alignment film is formed on one of the substrates by the vapor deposition apparatus shown in FIG. 2 and an alignment film for vertical alignment is formed on the other substrate by using an apparatus of the configuration conceptually shown in FIG. 13 through constant-speed rotary oblique vapor deposition method of rotating the substrate 1 at a constant speed during vapor deposition as indicated by an arrow 8 in FIG. 13. Incidentally, in each film formation, the distance between the vapor deposition source and the corresponding substrate is set to 1 meter. A projection type liquid crystal display device is assembled using the thus produced liquid crystal element.

A circularly polarized light is used as the polarized light for incidence on the liquid crystal element. As a result, there is obtained an image which has high uniformity and no variation in display due to the liquid crystal element.

### EXAMPLE 3

In this example, an optical system shown in FIG. 14 is used instead of the optical system shown in FIG. 12.

In FIG. 14, a light emitted from a light source 50 is converted into a linearly polarized light by passing though a linearly polarizing plate 51 and then converted into a circularly polarized light by passing through a quarter-wave plate (λ/4 plate) 52. Thereby, a liquid crystal element 120 is irradiated with the circularly polarized light.

In the case of an alignment state in which there is no retardation of the liquid crystal layer, the light is reflected in a state of the circularly polarized light by a reflecting plate (not shown) contained in the liquid crystal element 120. The circularly polarized light passes through the λ/4 plate 52 again to be converted into a linearly polarized light. At this time, the linearly polarized light becomes to have a polarization state of a polarization direction perpendicular to that of the incident polarized light. After that, the light reaches the linearly polarizing plate 51. However, the direction of the incident polarized light is a direction of the absorption axis of the linearly polarizing plate 51, the light will not exit to the outside. That is, it is a black state.

On the other hand, in the case of an alignment state in which the retardation of the liquid crystal layer satisfies λ/4 condition, a light which goes forward and back through the liquid crystal layer is subjected to modulation of λ/2 condition. In other words, the incident circularly polarized light passes through the liquid crystal layer having the retardation of the λ/2 condition to thereby become to have a polarization state which is opposite to that in the case where the liquid crystal layer has no retardation. In this state, the circularly polarized light passes though the λ/4 plate 52 again to be converted into a linearly polarized light. At this time, the linearly polarized light becomes to have a polarization state of a polarization direction in conformity with that of the incident polarized light. After that, the light reaches the linearly polarizing plate 51. However, the direction of the incident polarized light is a direction of the transmission axis of the linearly polarizing plate 51, the light can exit to the outside. That is, it is a white state.

Further, by controlling the retardation of the liquid crystal layer to be in an intermediate alignment state between zero and a λ/4 condition, a halftone state can be produced.

Thus, brightness modulation can be performed.

### EXAMPLE 4

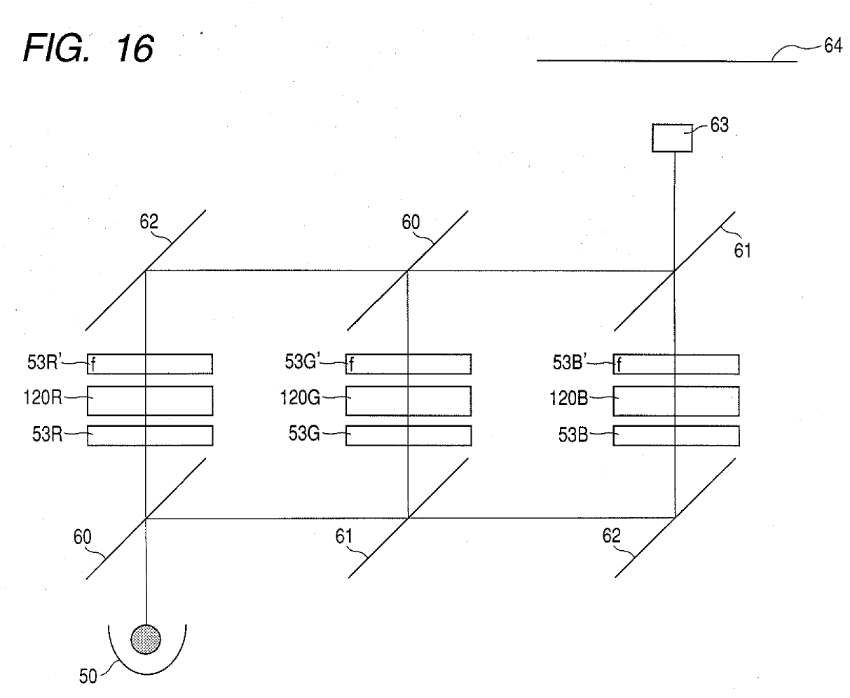

FIG. 16 is a schematic conceptual view showing a three-plate projection type liquid crystal display device including three liquid crystal elements for separately modulating three primary colors of R, G, and B. A light emitted from a light source 50 is separated into three colors of R, G, and B by a dichroic mirror 60 for transmitting only R and reflecting G and B, a dichroic mirror 61 for transmitting only B and reflecting R and G, and a total reflection plate 62 and enter three liquid crystal elements 120R, 120G, and 120B. Circularly polarizing means 53R, 53G, and 53B each having the structure shown in FIG. 15 are disposed on the incidence side of the respective liquid crystal elements to convert an incident light into a circularly polarized light of right rotation. When a voltage is not applied to a liquid crystal, the liquid crystal transmits the right circularly polarized light as such and is inclined depending on an applied voltage to modulate the incident light. When a maximum voltage is applied, a phase shift of λ/2 is provided, so that a left circularly polarized light exits.

On the exit side of the liquid crystal elements, there are also disposed circularly polarizing means 53R′, 53G′, and 53B′ of a configuration in which the disposition order of the linearly polarizing plate 51 and the λ/4 plate 52 of the circularly polarizing plate shown in FIG. 15 is reversed. The right circularly polarized light which has exited from the liquid crystal element having no voltage applied thereto is converted by the λ/4 plate located on the front side into a linearly polarized light whose polarization plane is perpendicular to the original linearly polarized light. Therefore, the linearly polarized light is absorbed by the linearly polarizing plate and does not exit therefrom. A left circularly polarized light which has exited from the liquid crystal element having a maximum voltage applied thereto is converted by the λ/4 plate located on the front side into a linearly polarized light whose polarization plane is parallel to that of the original linearly polarized light. Therefore, the linearly polarized light passes through the linearly polarizing plate to exit therefrom.

The lights which have exited from the respective liquid crystal elements are combined with one another by the dichroic mirrors 60, 61 and the total reflection mirror 62 and projected to a screen 64 by a projection optical system 63.

Each of the three liquid crystal elements is produced using an oblique vapor deposition film of SiO. Because the circularly polarized means is provided for each of the three liquid crystal elements, even when the optical axes are deviated from one another, the characteristics will not become uneven, so that an image with a stable color tone is obtained.

By applying anti-reflection treatment (AR treatment) to the surface of the polarizing plate, surface reflection can be suppressed to increase the contrast ratio. By adopting AR treatment conditions such that a wavelength region in which the anti-reflection effect is maximum, that is, the center wavelength of the AR treatment coincides with the displayed color of each of the liquid crystal elements used as the three-plate liquid crystal elements, it is possible to obtain a higher contrast ratio.

When anti-glare treatment is performed in addition to the AR treatment, the anti-reflection effect can be further improved to obtain a higher contrast.

### COMPARATIVE EXAMPLE

In this comparative example, alignment films are formed by the vapor deposition apparatus shown in FIGS. 7 and 8 to produce a liquid crystal element. At this time, the distance between the vapor deposition source and the substrate is set to 1 meter. The thus produced liquid crystal element is used to obtain a projection type liquid crystal display device.

Next, in an optical system used for the projection type liquid crystal display device, two types of polarized lights including a linearly polarized light and a circularly polarized light are used as a polarized light for incidence on the liquid crystal element to perform comparison. When an image displayed on each of the liquid crystal display devices is observed, a color deviation or in-plane distribution of color displaying is caused, whereby high-quality displaying cannot be obtained.

This application claims priority from Japanese Patent Application No. 2005-147354 filed on May 19, 2005, which is hereby incorporated by reference herein.

1. A liquid crystal display device, comprising a liquid crystal element comprising a pair of substrates, an alignment film provided on at least one of the pair of substrates and comprising an inclined columnar structure of an inorganic substance, and a liquid crystal disposed between the pair of substrates; and a light source, wherein a light from the light source is modulated and emitted, the liquid crystal display device further comprising means for converting the light from the light source into a circularly polarized light and making the circularly polarized light enter the liquid crystal element.

2. The liquid crystal display device according to claim 1, wherein the means for converting the light from the light source into the circularly polarized light and making the circularly polarized light enter the liquid crystal element comprises a linearly polarizing plate and a quarter-wave plate.

3. The liquid crystal display device according to claim 1, wherein the liquid crystal element comprises reflecting means, and reflects the incident circularly polarized light as a circularly polarized light of opposite rotation when no voltage is applied and reflects the incident circularly polarized light as a circularly polarized light of the same rotation when a voltage is applied.

4. The liquid crystal display device according to claim 3, wherein the reflected light exits through the quarter-wave plate and the linearly polarizing plate.

5. The liquid crystal display device according to claim 1, which comprises the liquid crystal element in plurality.

6. The liquid crystal display device according to claim 1, wherein one of the pair of substrates is a silicon substrate.

7. A method of producing a liquid crystal display device, comprising the steps of:
(1) disposing a substrate in a vacuum vessel having a vapor deposition source and a plate member with a slit disposed therein such that the substrate is within a plane parallel to the slit and is inclined with respect to a line connecting the vapor deposition source and the slit;
(2) radiating the substrate with a vapor from the vapor deposition source through the slit;
(3) moving the substrate in a direction which is perpendicular to a longitudinal direction of the slit and is parallel to a surface of the plate member;
(4) bonding the substrate to another substrate to form a cell;
(5) cutting the bonded two substrates into a plurality of cells;
(6) injecting a liquid crystal into the cell; and
(7) attaching the liquid crystal injected cell to an optical device having a circularly polarizing means.
